(19) United States
(12) Patent Application Publication
(10) Pub. No.: US 2019/0372487 A1
(43) Pub. Date: Dec. 5, 2019

(54) METHOD AND CONTROLLER FOR OPERATING AN ACTUATOR DEVICE, AND ACTUATOR SYSTEM

(71) Applicant: ZF FRIEDRICHSHAFEN AG, Friedrichshafen (DE)

(72) Inventors: Sascha Tränkner, Rehden (DE); Wolfgang Kliemannel, Lemförde (DE)

(73) Assignee: ZF FRIEDRICHSHAFEN AG, Friedrichshafen (DE)

(21) Appl. No.: 16/336,028

(22) PCT Filed: Sep. 7, 2017
(86) PCT No.: PCT/EP2017/072404

§ 371 Date: Mar. 22, 2019

(30) Foreign Application Priority Data
Sep. 28, 2016 (DE) 10 2016 218 761.9

(51) Int. Cl. H02P 6/16; G01D 5/12; H02P 6/00

(52) U.S. Cl. CPC H02P 6/16; H02P 6/006; G01D 5/12

(57) ABSTRACT

A method for operating an actuator device (120) is proposed. The actuator device (120) has a magnetic actuator (122), at least one magnetic field sensor (130) for detecting a magnetic field of the actuator (122), and a drive mechanism (124) for moving the actuator (122) between two mechanical end stops (126, 128) in relation to the at least one magnetic field sensor (130). The method has a step for inputting a sensor signal (135) from an interface for the at least one magnetic field sensor (130) and a drive signal (125) from an interface for the drive mechanism (124). The sensor signal (135) represents at least one magnetic field characteristic of a magnetic field of the actuator (122). The drive signal (125) represents a drive direction and a power consumption of the drive mechanism (124). The method also has a step for determining a position of the actuator (122) using the sensor signal (135) and/or the drive signal (125). The method also has a step for generating a status signal (147) based on the determined position. The status signal (147) represents an actuation state of the actuator device (120). Furthermore, the method also has a step for outputting the status signal (147) to an output interface.

The present invention relates to a method for operating an actuator device, a corresponding control device, an actuator system and a corresponding computer program product.

Encoded magnetic field plates can be used for detecting the positions of actuators in which a position is determined from a resulting bit sequence, i.e. if no sensor element is activated, this merely represents a position, for example.

Based on this, the present invention provides an improved method for operating an actuator device, an improved control device, an improved actuator system, and an improved computer program product according to the independent claims. Advantageous embodiments can be derived from the dependent claims and the following description.

According to embodiments of the present invention, each of three positions can also be determined by means of just one magnetic field sensor, for example, by also taking into account in particular the drive direction or rotating direction of a drive for the actuator device and a power consumption or current consumption of the drive. In other words, it is possible to obtain a one-to-one position detection for three positions, for example, of an actuator that is moved by a drive with just one digital sensor or magnetic field sensor. The detection can also be obtained, for example, indirectly, through detection of a transition region between signal edges of a magnetic field sensor and an increase in the power consumption of the drive as a function of the drive direction and a mechanical end stop.

Advantageously, according to embodiments of the present invention, it is possible to economically detect, e.g., three positions of an actuator device with just one digital sensor or magnetic field sensor. As a result, a clear and reliable detection of, e.g., three positions of an actuator system can be obtained with just one sensor. By taking into account the drive direction, or rotational direction of the drive for the actuator device, three positions can be encoded or recorded, for example, with one sensor. Positions can also be checked for plausibility based on a drive current, for example, as a result of the mechanical end stops.

A method for operating an actuator device is presented, wherein the actuator device has a magnetic actuator, at least one magnetic field sensor for detecting a magnetic field of the actuator, and a drive mechanism for moving the actuator between two mechanical end stops in relation to at least one magnetic field sensor, characterized in that the method includes at least the following steps:

Inputting a sensor signal from an interface for the at least one magnetic field sensor and a drive signal from an interface for the drive mechanism, wherein the sensor signal represents at least one magnetic field characteristic of a magnetic field of the actuator, wherein the drive signal represents a drive direction and a power consumption of the drive mechanism;

Determining a position of the actuator by means of the sensor signal and/or the drive signal; Generating a status signal by means of the determined position, wherein the status signal represents an actuation state of the actuator; and

Outputting the status signal at an output interface.

The actuator device can be used, for example, in a vehicle or in conjunction with a vehicle, or it can be intended for a vehicle. The vehicle can be a motor vehicle. In particular, the actuator device can be implemented or used as part of a parking lock actuator or as a parking lock actuator of a vehicle. The magnetic field characteristic can be a change or a field strength, etc. of the magnetic field represented by the actuator. The magnetic field sensor can be a digital sensor.

The drive direction can be a rotational direction of the drive mechanism. The power consumption of the drive mechanism can represent an electrical current consumption. The determined position of the actuator can be assigned to an operating state of the actuator device.

According to one embodiment, the position of the actuator can be determined in the determining step by using a curve of at least one signal edge of the sensor signal. The curve of a signal edge can rise or fall thereby. Such an embodiment offers the advantage that a movement state, and thus a position of the actuator between the end stops can be easily and reliably determined.

The position of the actuator can also be determined in the determining step by the drive direction and, additionally or alternatively, the power consumption of the drive mechanism. The end stop toward which the actuator is moving can be concluded from the drive direction. It can be concluded from the power consumption whether the actuator already bears on one of the end stops. Such an embodiment offers the advantage that two positions of the actuator at the ends of its movement path can be easily and reliably determined.

Advantageously, the position of the actuator can be determined in the determining step as a first position at a first end stop, a second position between the end stops, or a third position at a second end stop. In the first and third positions, the actuator can bear on one of the end stops. In the second position, the actuator can be at a spacing to the end stops. Such an embodiment offers the advantage that three positions can be clearly determined.

In the determining step, the first position or the third position can be determined as a function of the drive direction of the drive mechanism, when the power consumption of the drive mechanism exhibits a predefined rising characteristic toward a signal edge of the sensor signal. The second position can also be determined in the determining step independently of the drive direction of the drive mechanism when there is a transition region between two signal edges of the sensor signal. The second position can be obtained when the sensor signal indicates the transition region. Such an embodiment offers the advantage that it is possible to reliably and clearly detect three different positions, wherein one position can be detected directly by the magnetic field sensor, and two positions can be detected indirectly, based on the drive direction or rotational direction of the drive and based on the signal curve of the magnetic field sensor.

The method can also include a step for activating the drive mechanism. The drive mechanism can be activated in the activating step by the drive signal, and additionally or alternatively, by the status signal. Such an embodiment offers the advantage that the actuator device can be reliably actuated, in particular with an exact knowledge of a current actuation state and an actuation state reached after the actuation.

The drive mechanism can be activated in the activating step in order to move the actuator to a target position. At least the input step and the determining step can be carried out in response to the activation step in order to determine whether the actuator has moved in response to the activation step. The drive mechanism can also be activated with just the drive signal in the activating step. Such an embodiment offers the advantage that when the actuator device is activated, the actuator can move quickly and easily to a target position, and it can be concluded based on this whether the actuator has moved to a position or not when it has been activated.

Furthermore, a signal curve of the sensor signal can be checked for plausibility in the determining step based on the drive direction and, additionally or alternatively, the power consumption of the drive mechanism. Such an embodiment offers the advantage that it is possible to reliably and quickly check the plausibility of the signal curve based on the drive current at the end stop.

A control device is also presented, which is configured to execute the steps of an embodiment of the method specified above.

The method for operation by means of the control device can thus be advantageously executed. The control device can be an electric device, which processes electrical signals, and outputs control signals on the basis thereof. The control device can have one or more appropriate interfaces for this, which can be in the form of hardware or software. If the interfaces are hardware interfaces, they can be part of an integrated circuit, for example, in which the functions of the control device are implemented. The interfaces can also be distinct integrated circuits, or be composed at least in part of discrete components. If the interfaces are software interfaces, they can be software modules on a microcontroller, for example, together with other software modules.

An actuator system is also presented, which has at least the following features:

At least one actuator device, which has a magnetic actuator, at least one magnetic field sensor for detecting a magnetic field of the actuator, and a drive mechanism for moving the actuator between two mechanical end stops in relation to the at least one magnetic field sensor; and an embodiment of the control device specified above, wherein the control device is or can be connected to the at least one actuator device for signal transmission.

An embodiment of the control device specified above can be advantageously implemented or used in conjunction with the actuator system to operate the actuator device, in particular to determine an actuation state of the actuator device, and, additionally or alternatively, to activate the actuator device. The actuator system can be used in a vehicle or in conjunction with a vehicle, or be intended for a vehicle, for example. The vehicle can be a motor vehicle. In particular, the actuator system can be implemented or used as part of a parking lock actuator, or as a parking lock actuator for a vehicle, or as part of a vehicle transmission.

According to one embodiment, the actuator can be elongated. For this, the actuator can exhibit a first magnetic pole at two opposing end sections, and a second magnetic pole in a middle section between the end sections. Such an embodiment offers the advantage that a meaningful sensor signal can be obtained from this actuator by means of the magnetic field sensor.

The at least one magnetic field sensor can also be located between the end stops. In particular, the at least one magnetic field sensor can be located in the middle, between the end stops. Such an embodiment offers the advantage that a position differing from the positions of the actuator when it bears on an end stop can be easily and directly detected.

The actuator device can also have numerous magnetic field sensors. Such an embodiment offers the advantage that the reliability of the actuator device can be increased through redundancy, and simple errors can be detected and corrected. By using numerous magnetic field sensors, which can detect a position of the actuator between the end stops, for example, at least one safety-relevant position can be encoded, and the availability thereof can be obtained in the event of a simple error.

In addition, the actuator device or the control device can have an activation mechanism for activating the drive mechanism. Such an embodiment offers the advantage that the actuator device can be safely operated, in particular with exact knowledge of an actuation state prior to the actuation and after the actuation.

The invention also comprises an advantageous computer program product, which has program code that can be stored on a machine readable medium, such as a semiconductor memory, a hard drive memory, or an optical memory, and which is used for executing the method according to any of the embodiments described above, when the program is executed on a computer or control device.

The invention shall be explained in greater detail based on the attached drawings. Therein:

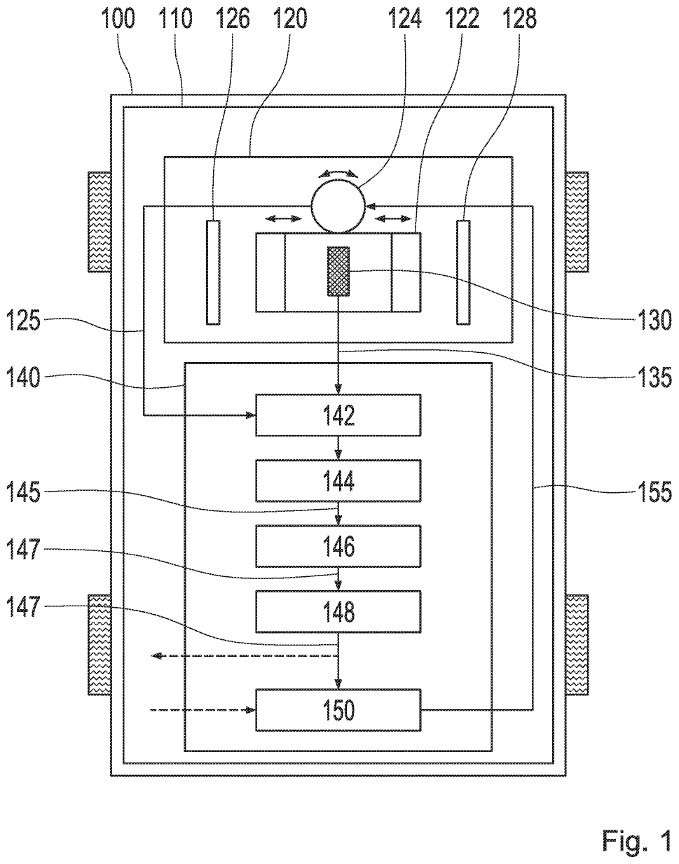

FIG. 1 shows a schematic illustration of an actuator system according to an exemplary embodiment of the present invention, in a vehicle;

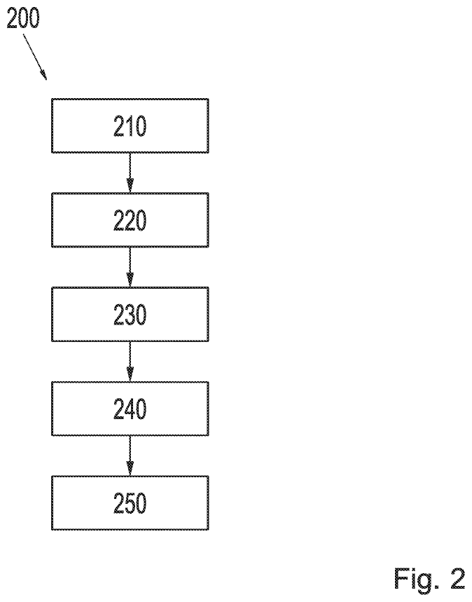

FIG. 2 shows a flow chart for a method for operation according to an exemplary embodiment of the present invention;

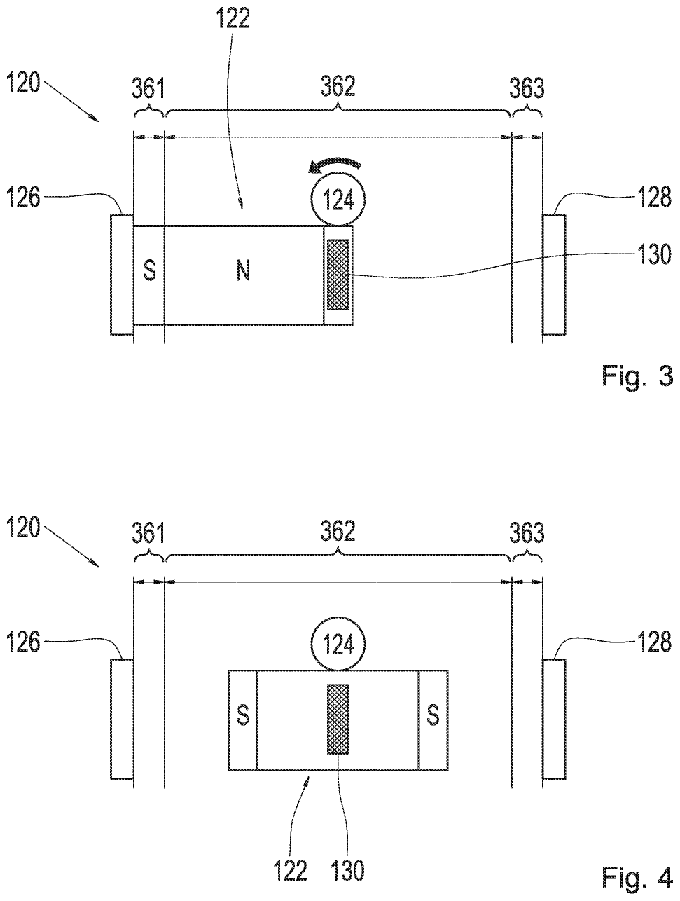

FIG. 3 shows a schematic illustration of a first actuation state of the actuator device shown in FIG. 1,

FIG. 4 shows a schematic illustration of a second actuation state of the actuator device shown in FIG. 1; and

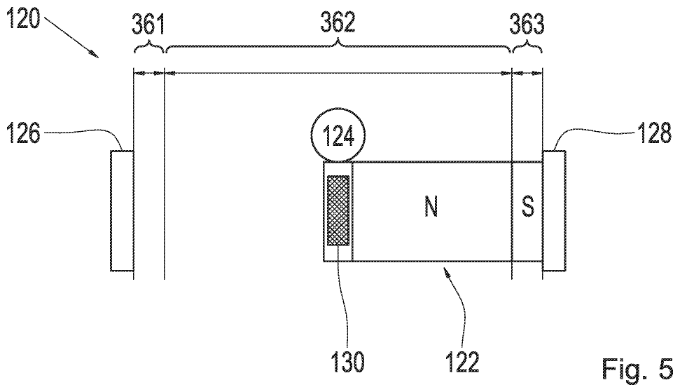

FIG. 5 shows a schematic illustration of a third actuation state of the actuator device shown in FIG. 1.

In the following description of preferred exemplary embodiments of the present invention, identical or similar reference symbols shall be used for the elements having similar functions depicted in the various figures, wherein there shall be no repetition of the descriptions of these elements.

FIG. 1 shows a schematic illustration of an actuator system 110 in a vehicle 100, according to an exemplary embodiment of the present invention. Only one actuator device 120 and one control device 140 of the actuator system 110 are shown, by way of example, in the exemplary embodiment of the present invention shown in FIG. 1. The control device 140 is configured to operate the actuator device 12. The actuator device 120 and the control device 140 are connected to one another for signal transmission.

The actuator device 120 has a magnetic actuator 122, a drive mechanism 124, a first mechanical end stop 126, and a second mechanical end stop 128, and just one magnetic field sensor 130, by way of example. According to one embodiment, the actuator device 120 can have numerous magnetic field sensors 130.

The drive mechanism 124 of the actuator device 120 is configured to move the actuator 122 in relation to the magnetic field sensor 130 between the first end stop 126 and the second end stop 128. A drive signal 125 can be picked up at the drive mechanism 124. The drive signal represents a drive direction or rotational direction and a power consumption or electrical current consumption of the drive mechanism 124.

The magnetic field sensor 130 of the actuator device 120 is configured to detect a magnetic field of the actuator 122. The magnetic field sensor 130 is also configured to provide a sensor signal 135. The sensor signal 135 represents at least one magnetic field characteristic of the magnetic field of the actuator 122, e.g. a magnetic field strength or the like. The magnetic field sensor is located between the first end stop 126 and the second end stop 128.

The control device 140 has an input device 142, a determining device 144, a generating device 146, and an output device 148. The input device 142 is configured to input the drive signal 125 from an interface for the drive device 124 and the sensor signal 135 from an interface for the magnetic field sensor. The input device 142 is also configured to forward the drive signal 125 and the sensor signal 135 to the determining device 144.

A determining device 144 of the control device 140 is configured to determine a position of the actuator 122 of the actuator device 120 based on the drive signal 125 and/or the sensor signal 135. The determining device 144 is also configured to output position data 145 representing the determined position to the generating device 146 or to provide the like.

The generating device 146 of the control device 140 is configured to receive the position data 145. The generating device is also configured to generate a status signal 147 based on the determined position. The status signal 147 represents an actuation state of the actuator device 120. The actuation state correlates in particular with the position of the actuator element 122 of the actuator device 120.

The output device 148 of the control device 140 is configured to output the generated status signal 147 to an output interface. The output interface forms an electrical connection to the output device 148 or the control device 140, respectively.

According to the exemplary embodiment of the present invention shown in FIG. 1, the control device also has an activation mechanism 150 for activating the drive mechanism 124 based on the status signal 147 and/or the drive signal 125, or a signal derived therefrom. The output device 148 is configured to output the generated status signal 147 to the output interface for the activation mechanism 150, and optionally another mechanism.

The activation mechanism 150 is configured to output an activation signal 155 to the drive mechanism 124. The activation signal 155 is at least partially derived from the drive signal 125 and/or the status signal 147. Optionally, the activation mechanism 150 can also receive an activation signal from outside the control device 140. According to another exemplary embodiment, the control mechanism 150 can also be outside the control device 140 and form a part of the actuator device 120.

FIG. 2 shows a flow chart for an operating method 200 according to an exemplary embodiment of the present invention. The method 200 is a method 200 for operating an actuator device. The operating method 200 can be executed in order to operate an actuator device, which corresponds or is similar to the actuator device in FIG. 1. The operating method 200 can be executed by the control device in FIG. 1 or a similar control device. The control device in FIG. 1 is configured to execute the steps of the operating method 200 in corresponding devices.

In an input step 210, a sensor signal is input by an interface for the at least one magnetic field sensor and a drive signal is input by an interface for the drive mechanism. The sensor signal represents at least one magnetic field characteristic of a magnetic field of the actuator. The drive signal represents a drive direction and a power consumption of the drive mechanism.

Subsequently, in a determining step 220, a position of the actuator is determined based on the sensor signal and/or the drive signal. Then, in a generating step 230, a status signal is generated on the basis of the determined position, which represents an actuation state of the actuator device. Subsequently, in an output step 240, the status signal is output to the output interface.

According to one exemplary embodiment, the position of the actuator is determined in the determining step 220 using a curve of at least one signal edge of the sensor signal. According to another exemplary embodiment, the position of the actuator is determined in the determining step 220 using the drive direction and/or the power consumption of the drive mechanism.

According to the exemplary embodiment of the present invention illustrated in FIG. 2, the operating method 200 also has a step 250 for activating the drive mechanism. The drive mechanism is activated in the activation step 250 using the drive signal and/or the status signal.

Steps 210, 220, 230, 240 and/or 250 of the operating method 200 can be executed repeatedly and/or continuously.

FIG. 3 shows a schematic illustration of a first actuation state of the actuator device 120 in FIG. 1. According to the exemplary embodiment shown therein, the actuator 122 is elongated. It can be seen therein that the actuator 122 has a first magnetic pole at two opposing end sections, in this case the magnetic south pole S, merely by way of example, and a second magnetic pole in a middle section, between the end sections, the magnetic north pole N in this case, merely by way of example. Furthermore, a first position 361, a second position 362 and a third position 363 of the actuator are indicated in FIG. 3.

In the first actuation state, the actuator 122 is located at the first end stop 126. At this point, the actuator 122 is located at the first position 361. More precisely, one of the end sections of the actuator 122 bears on the first end stop 126. Furthermore, an initiation of a movement of the actuator 122 is indicated symbolically by a rotation of the drive mechanism 124.

FIG. 4 shows a schematic illustration of a second actuation state of the actuator device 120 in FIG. 1. The illustration in FIG. 4 corresponds to the illustration in FIG. 3, with the exception that the actuator 122 is spaced apart from the first end stop 126 and the second end stop 128.

FIG. 5 shows a schematic illustration of a third actuation state of the actuator device 120 in FIG. 1. The illustration in FIG. 5 corresponds to the illustrations in FIG. 3 and FIG. 4, with the exception that the actuator 122 is in the third position 363. The actuator 122 is then located at the second end stop 128. More precisely, the other end section of the actuator 122 bears on the second end stop 128.

It can be seen in that in reference to the figures described above, the position of the actuator 122 can be determined as the first position 361 at the first end stop 126, the second position 362 between the end stops 126 and 128, or the third position 363 at the second end stop 128 by means of the determining mechanism 144 of the control device, or in the determining step 220. The first position 361 and the third position 363 can be determined as a function of the drive direction of the drive mechanism 124, when the power consumption of the drive mechanism 124 displays a predefined characteristic rising toward a signal edge of the sensor signal 135. The predefined rising characteristic can be a rising curve that exceeds a threshold value. The second position 362 can be determined independently of the drive direction of the drive mechanism 124 when there is a transition region between two signal edges of the sensor signal 135.

Starting from the first position of the first actuation state, the third position 363 or the third actuation state is reached in that the drive mechanism 124 is rotated in the counter-clockwise direction. The magnetic field sensor 130 first records a rising and subsequently falling edge of the sensor signal 135 (or vice versa in a different design of the actuator 122), wherein a transition region between the rising and falling edges represents the second position 362, or the second actuation state. The drive current increases after the falling edge in the sensor signal 135, because the actuator 122 is driven against the second mechanical end stop 128.

Starting from the third position 363, the first position 361 is reached when the drive mechanism 124 is rotated in the clockwise direction. In this case, the magnetic field sensor first records a rising edge of the sensor signal 135 and subsequently a falling edge (or vice versa in a different design of the actuator 122), wherein the second position 362 is represented in a transition region between the rising and falling edges. The drive current increases after the falling edge in the sensor signal 135, because the actuator 122 is driven against the first mechanical end stop 126.

According to one exemplary embodiment, the drive mechanism can be activated by means of the activation mechanism 150 or in the activation step 250, in order to move the actuator 122 to a target position. In response, it can be determined, in particular by means of the determining mechanism 144 or by executing at least the input step 21 and the determining step 220, whether or not the actuator 122 has moved in response to the activation signal 155 or the activation step 250. A signal curve of the sensor signal 135 can also be checked for plausibility according to one exemplary embodiment by means of the determining mechanism 144 or in the determining step 220 based on the drive direction and/or the power consumption of the drive mechanism 124.

In other words, when a target position is specified, the current position of the actuator 122, or the current actuation state of the actuator device 120 can be checked, if an actual position or an actual actuation state is not known after an initiation. The first position 361 can be checked in that the drive mechanism 124 is supplied with current in the counter-clockwise direction. If there is no change in the sensor signal 135 and motor current increases, the first position 361 has been reached. The third position can be checked in that the drive mechanism 124 is supplied with current in the clockwise direction. If there is no change in the sensor signal 135, and the motor current increases, the third position 363 has been reached.

If an exemplary embodiment contains an “and/or” conjunction between a first feature and a second feature, this can be read to mean that the exemplary embodiment according to one embodiment includes both the first feature and the second feature, and according to another embodiment, includes either just the first feature or just the second feature.

### REFERENCE SYMBOLS

100 vehicle
110 actuator system
120 actuator device
122 actuator
124 drive mechanism
125 drive signal
126 first end stop
128 second end stop
130 magnetic field sensor
135 sensor signal
140 control device
142 input device
144 determining device
145 position data
146 generating device
147 status signal
148 output device
150 activation mechanism
155 activation signal
200 operating method
210 input step
220 determining step
230 generating step
240 output step
250 activation step
361 first position
362 second position
363 third position

1. A method for operating an actuator device, wherein the actuator device includes a magnetic actuator, at least one magnetic field sensor for detecting a magnetic field of the actuator, and a drive mechanism for moving the actuator between two mechanical end stops in relation to the at least one magnetic field sensor, characterized in that the method includes at least the following steps:
inputting a sensor signal from an interface for the at least one magnetic field sensor and a drive signal from a first interface for the drive mechanism, wherein the sensor signal represents at least one magnetic field characteristic of a magnetic field of the actuator, wherein the drive signal represent a drive direction and a power consumption of the drive mechanism;
determining a position of the actuator based on the sensor signal and/or the drive signal;
generating a status signal based on the determined position, wherein the status signal represents an actuation state of the actuator device; and
outputting the status signal to an output interface.

2. The method according to claim 1, characterized in that the position of the actuator is determined on the basis of a curve of at least one signal edge of the sensor signal in the determining step.

3. The method according to claim 1, characterized in that the position of the actuator is determined on the basis of the drive direction and/or the power consumption of the drive mechanism in the determining step.

4. The method according to claim 1, characterized in that the position of the actuator is determined as the first position at a first end stop, as a second position between the end stops, or as a third position at a second end stop in the determining step.

5. The method according to claim 4, characterized in that the first position or the third position is determined as a function of the drive direction of the drive mechanism, when the power consumption of the drive mechanism displays a predefined characteristic rising toward a signal edge of the sensor signal, and the second position is determined independently of the drive direction of the drive mechanism when there is a transition region between the signal edges of the sensor signal in the determining step.

6. The method according to claim 1, characterized by an activating step for activating the drive mechanism wherein the drive mechanism is activated by the drive signal and/or the status signal in the activating step.

7. The method according to claim 6, characterized in that the drive mechanism is activated in the activating step in order to move the actuator to a target position, wherein at least the input step and the determining step are executed in response to the activating step, in order to determine whether the actuator has moved in response to the activating step.

8. The method according to claim 1, characterized in that a signal curve of the sensor signal is checked for plausibility in the determining step on the basis of the drive direction and/or the power consumption of the drive mechanism.

9. A control device configured to execute the steps of a method according to claim 1.

10. An actuator system, characterized in that the actuator system has at least the following features:
at least one actuator device that has a magnetic actuator, at least one magnetic field sensor for detecting a magnetic field of the actuator, and a drive mechanism for moving the actuator between two mechanical end stops in relation to the at least one magnetic field sensor; and
a control device according to claim 1, wherein the control device is or can be connected to the at least one actuator device for signal transmission.

11. The actuator system according to claim 10, characterized in that the actuator is elongated, wherein the actuator has a first magnetic pole (S) at two opposing end sections, and a middle section between the end sections has a second magnetic pole (N).

12. The actuator system according to claim 10, characterized in that the at least one magnetic field sensor is located between the end stops.

13. The actuator system according to claim 10, characterized in that the actuator device has numerous magnetic field sensors.

14. The actuator system according to claim 10, characterized in that the actuator device or the control device for activating the drive mechanism.

15. A computer program product with program code for executing a method according to claim 1 when the computer program product is executed on a control device.

16. The method according to claim 2, characterized in that the position of the actuator is determined on the basis of the drive direction and/or the power consumption of the drive mechanism in the determining step.

17. The method according to claim 2, characterized in that the position of the actuator is determined as the first position at a first end stop, as a second position between the end stops, or as a third position at a second end stop in the determining step.

18. The method according to claim 2, characterized by an activating step for activating the drive mechanism, wherein the drive mechanism is activated by the drive signal and/or the status signal in the activating step.

19. The method according to claim 2, characterized in that a signal curve of the sensor signal is checked for plausibility in the determining step on the basis of the drive direction and/or the power consumption of the drive mechanism.

20. The actuator system according to claim 11, characterized in that the at least one magnetic field sensor is located between the end stops.
